(19) United States
(12) Patent Application Publication
(10) Pub. No.: US 2022/0112719 A1
(43) Pub. Date: Apr. 14, 2022

(54) Rebar Splicer Capable of Enabling Quick Visual Measuring of a Predetermined Torque Value

(71) Applicant: Su-I Lim, New Taipei City (TW)

(72) Inventors: Su-I Lim, New Taipei City (TW); Tien-Lee Yang, Taoyuan City (TW)

(73) Assignee: Su-I Lim

(21) Appl. No.: 17/247,428

(22) Filed: Dec. 10, 2020

(30) Foreign Application Priority Data
Oct. 9, 2020 (CN) 202011072164.7

(51) Int. Cl. E04C 5/16; F16B 7/18

(52) U.S. Cl. CPC E04C 5/165; F16B 7/182

(57) ABSTRACT

Provided is a rebar splicer enabling quick visual measuring of a predetermined torque value, comprising: a female splicing piece and at least one male splicing piece. The female splicing piece includes a body, at least one end portion, and at least one connecting portion. The at least one connecting portion is disposed between at least one end of the body and the at least one end portion, and at least one groove is formed around the outer side of the at least one connecting portion surrounding circumferential direction. The at least one connecting portion has a thickness smaller than the thickness of at least one end portion and the thickness of the body. The present invention enables inspectors to quickly visually check whether a predetermined torque value is reached, thereby judging whether the locked is secured, avoiding complicated inspection, shortening working hours, and having high efficiency.

### CROSS-REFERENCE TO RELATED APPLICATION

This application claims priority to Chinese patent application No. 202011072164.7, filed on Oct. 9, 2020, which is incorporated herewith by reference.

### BACKGROUND OF THE INVENTION

### 1. Field of the Invention

The present invention relates generally to a rebar splicer, and more particularly, to a rebar splicer capable of enabling quick visual measuring of a predetermined torque value.

### 2. The Prior Arts

In construction and civil engineering, both reinforced concrete (RC) structures and steel reinforced concrete (SRC) structures require the use of steel rebar to construct the structures. In order to facilitate transportation and storage, the manufactured steel rebar will be cut into specific lengths at the steel rebar manufacturing site before being transported to the construction site for use. Because the height of each building is different, it is usually necessary to use a specific construction method to connect steel rebar to extend the length, and the strength of the connection must be considered. It is one of the common construction methods in the industry to use a steel splicer to connect two steel rebar.

There are two ways for rebar splicers to splice two rebars: The first type of rebar splicer includes a female splicer and two male splicers. One end of each male splicer is welded to the end of a steel rebar. The two male splicers respectively pass through the two ends of the female splicer and are fixed in the female splicer. The second type of rebar splicer includes a female splicer and a male splicer. One end of the female splicer is welded to the end of a steel rebar, and one end of the male splicer is welded to the end of another steel rebar. The other end of the male splicer passes through one end of the female splicer and is fixed in the female splicer.

Generally speaking, the inspector usually uses a torque wrench to tighten the rebar splicer. If the torque wrench shows that the actual torque value of the rebar splicer reaches a predetermined torque value, it means that the rebar splicer is fully locked. If the torque wrench shows that the actual torque value of the rebar splicer is lower than the predetermined torque value, it means that the rebar splicer has not been locked.

If the rebar splicer is not locked, the structural strength of the piece will be affected, and the earthquake resistance will also decrease. In the event of a strong earthquake, the rebar splicer will not be able to perform its due role. Therefore, all steel rebar splicer of the building must be locked to ensure that the building has a certain degree of earthquake resistance.

However, the number of rebar splicers used in construction and civil engineering is very large, and manual operations will inevitably be overlooked. When some rebar splicers may be partially or not locked, because it is impossible to visually judge whether the rebar splicer has reached the predetermined torque value by visual inspection, it is impossible to visually distinguish which rebar splicers are completely locked, partially locked or not locked by visual inspection only. The inspector needs to use a torque wrench to check one by one. The project is very large, time-consuming and laborious.

### SUMMARY OF THE INVENTION

A primary objective of the present invention is to provide a rebar splicer enabling quick visual detecting of a predetermined torque value, which can enable the inspectors to quickly visually determine whether the rebar splicer reaches the predetermined torque value, thereby judging whether it is locked, eliminating complicated inspection procedures, and shortening labor Time, high efficiency.

For achieving the foregoing objective, the present invention provides a rebar splicer that can quickly and visually detect a predetermined torque value, which includes a female splicing piece and at least one male splicing piece; the female splicing piece comprising: a body, at least one end portion, and at least one connecting portion; the at least one connecting portion being disposed between at least one end of the body and the at least one end portion, and at least one groove being formed around outer side of the at least one connecting portion along a circumferential direction; the thickness of at least one connecting portion being smaller than the thickness of at least one end portion and the thickness of the body; the at least one male splicing piece passing through the at least one end portion and the at least one connecting portion and being fixed in the body.

Preferably, the at least one groove has a width in an axial direction, the width is tapered from the outside to the inside, and the deepest part of the at least one groove corresponds to the thinnest part of the at least one connecting portion.

Preferably, the female splicing piece is provided with at least one screw hole and at least one through hole, the at least one through hole communicates with the at least one screw hole, and a junction between the at least one through hole and the at least one screw hole is located on the same plane with the thinnest part of the at least one connecting portion; the at least one male splicing piece has a screw part, and the at least one screw part passes through the at least one through hole and is screwed and fixed in the at least one screw hole.

Preferably, the cross-sectional shape of the at least one groove is V-shaped.

Preferably, the at least one through hole is a round hole.

Preferably, the at least one end portion is polygonal.

Preferably, the female splicing piece comprises two end portions and two connecting portions, the two connecting portions are respectively disposed between the two ends of the body and the two end portions, and a groove is formed on outer side of each connecting part along a circumferential direction, so that the thickness of each connecting portion is less than the thickness of each end portion and the thickness of the body; and wherein, the rebar splicer comprises two male splicing pieces, the two male splicing pieces respectively pass through the two end portions and the two connecting portions and is fixed in the body.

The effect of the present invention is that the rebar splicer of the present invention can enable the inspectors to quickly visually check whether the rebar splicer has reached the predetermined torque value, thereby judging whether it is locked, avoiding complicated inspection procedures, shortening working hours, and achieving high efficiency.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a perspective view of a female splicing piece of the first embodiment of the present invention;

FIG. 2 is a top view of the female splicing piece of the first embodiment of the present invention;

FIG. 3 is an exploded view of the first embodiment of the present invention;

FIG. 4 is an assembly view of the first embodiment of the present invention;

FIG. 5 is a schematic view showing the fracture of two connecting portions of the first embodiment of the present invention;

FIG. 6 is an exploded view of the second embodiment of the present invention;

FIG. 7 is an exploded view of the third embodiment of the present invention; and

FIG. 8 is an exploded view of the fourth embodiment of the present invention.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

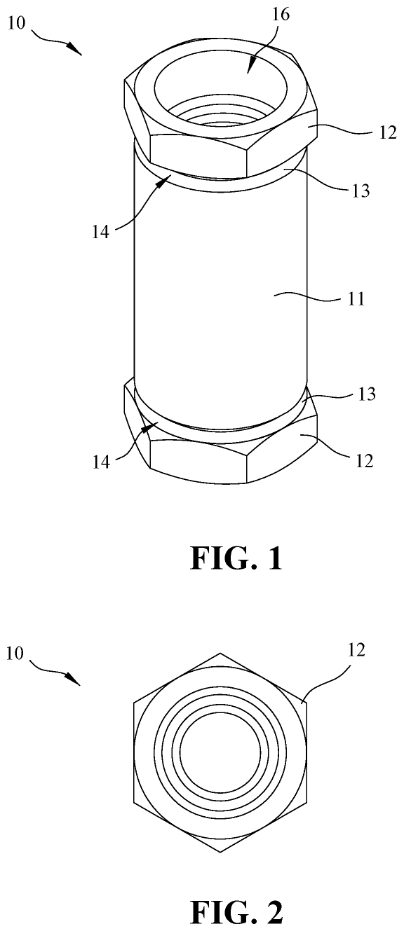

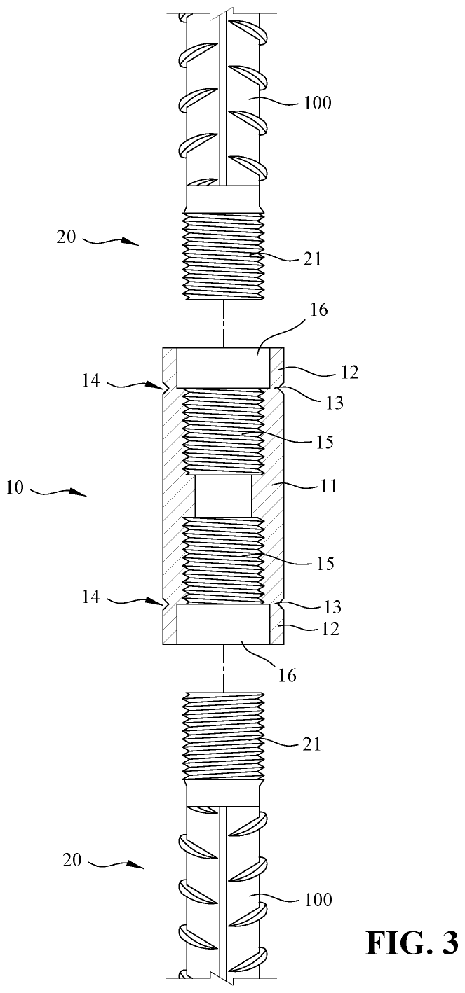

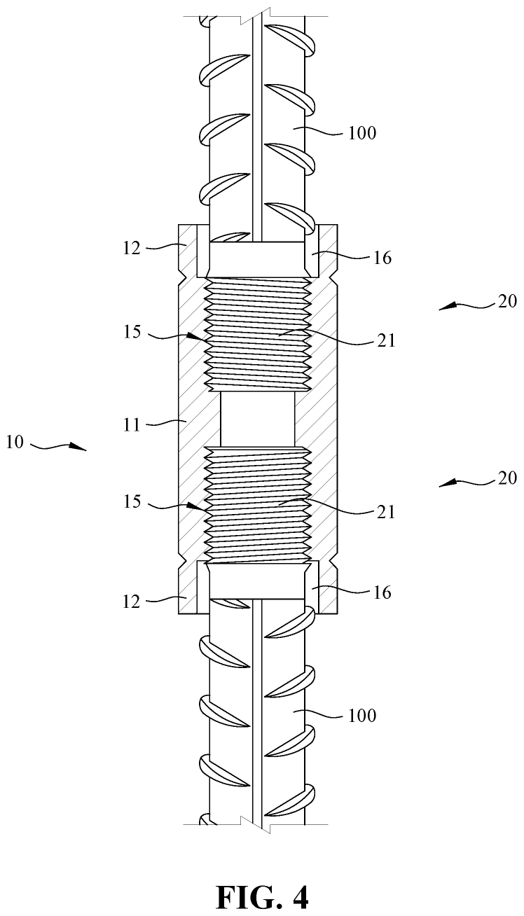

Referring to FIG. 1 to FIG. 4, FIG. 1 is a perspective view of a female splicing piece 10 of the first embodiment of the present invention; FIG. 2 is a top view of the female splicing piece 10 of the first embodiment of the present invention; FIG. 3 is an exploded view of the first embodiment of the present invention; FIG. 4 is an assembly view of the first embodiment of the present invention. The present invention provides a rebar splicer that can quickly and visually detect a predetermined torque value, which includes a female splicing piece 10 and two male splicing pieces 20.

As shown in FIGS. 1-3, the female splicing piece 10 comprises: a body 11, two end portions 12, and two connecting portions 13. The two connecting portions 13 are disposed between the two ends of the body 11 and the two end portions 12 respectively. A groove 14 is formed around outer side of each connecting portion 13 along a circumferential direction, so that the thickness of each connecting portion is smaller than the thickness of each end portion 12 and the thickness of the body 11.

As shown in FIG. 3, each male splicing piece 20 has one end welded respectively to a steel rebar 100. As shown in FIG. 4, the other end of each male splicing piece 20 respectively passes through the end portion 12 and the connecting portion 13 to be fixed inside the body 11.

Because the two grooves 14 are formed on the outside of the two connecting portions 13 and the thickness of the two connecting portions 13 is less than the thickness of the two end portions 12 and the thickness of the body 11, the torque value that the two connecting parts 13 can withstand is equal to the predetermined torque value when the body 11 and the male splicing piece 20 are tightly locked.

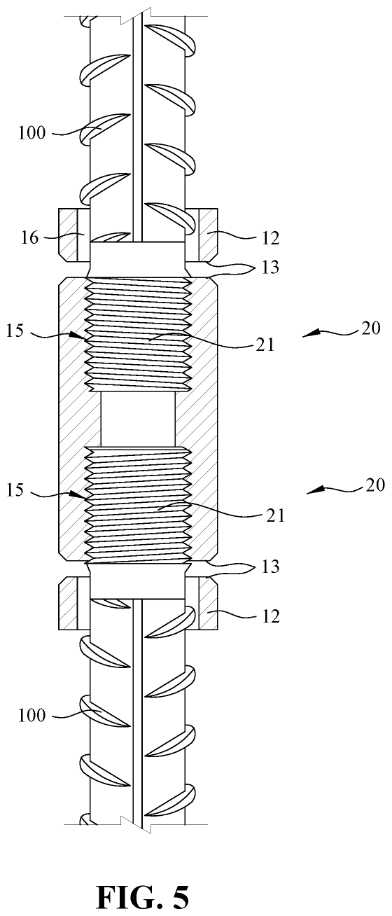

Referring to FIG. 5, FIG. 5 is a schematic view showing the fracture of two connecting portions 13 of the first embodiment of the present invention. A wrench (not shown) is sleeved on one end portion 12. The end portion 12 is rotated by the wrench to drive the body 11 to rotate relative to one of the male splicing piece 20. After the force exerted by the wrench exceeds the torque value that one of the connecting portions 13 can withstand, one of the connecting portions 13 is immediately broken, and one end portion 12 is separated from the body 11. At this point, the actual torque value between the body 11 and one of the connecting portions 20 is exactly equal to the predetermined torque value when tightly locked, achieving the effect of complete locking. A wrench (not shown) is sleeved on the other end portion 12, and the other end portion 12 is rotated by the wrench to drive the body 11 to rotate relative to the other male splicing piece 20. After the force exerted by the wrench exceeds the torque value that the other connecting portion 13 can withstand, the other connecting portion 13 is immediately broken, and the other end portion 12 is separated from the body 11. At this point, the actual torque value between the body 11 and the other male splicing piece 20 is exactly equal to the predetermined torque value when tightly locked, achieving the effect of complete locking.

Thereby, when the inspector is locking the rebar splicer of the present invention, as long as the two connecting portions 13 are seen broken visually, they can immediately know that the actual torque value between the body 11 and the two male splicing pieces 20 is just equal to the predetermined torque value at the time of locking, the steel rebar splicer of the present invention has been completely locked. Therefore, there is no need to use a torque wrench to measure the actual torque value between the body 11 and the two male splicing pieces 20, and any type of wrench can be used to lock the rebar splicer of the present invention.

Because the number of rebar splicers used in construction and civil engineering is very large, erroneous oversight in manual work is virtually inevitable. There may be some rebar splicers that are only partially or not locked, so the inspectors need to be sent to inspect the rebar splicers one by one. The partial locking means that one connecting portion 13 is broken and the other connecting portion 13 is not broken, which means that the body 11 and one of the male splicing piece 20 are locked, and the body 11 and the other male splicing piece 20 are not locked. The “not locked” means that the two connecting portions 13 are not broken and are intact as before, which means that the body 11 and the two male splicing pieces 20 are not locked. In the process of inspecting one by one, as long as the inspectors see whether the two connecting portions 13 of all the female splicing pieces 10 are broken, the inspectors can distinguish which rebar splicers of the present invention are fully locked, partially locked or not locked. The fully locked rebar splicer of the present invention can be directly skipped. The inspector only needs to fully lock the rebar splicer of the present invention for the partially locked and not locked, which eliminates the need for conventional complicated inspection procedures, shortens working hours and achieves high efficiency.

As shown in FIG. 1 and FIG. 3, each groove 14 has a width in an axial direction, and the width is tapered off, i.e., decreasing, from the outside to the inside. The deepest part of each groove 14 corresponds to the thinnest part of each connecting portion 13. The torsion value that the thinnest part of the two connecting portions 13 can withstand is equal to the predetermined torque value when the body 11 and the male splicing piece 20 are locked. As shown in FIG. 5, after the force applied by the wrench exceeds the torsion value that the thinnest part of the two connecting portions 13 can withstand, the two connecting portions 13 immediately break off from the thinnest part.

As shown in FIGS. 1-4, the female splicing element 10 is disposed with two screw holes 15 and two through holes 16, the two through holes 16 communicate respectively with the two screw holes 15, and a junction between each through hole 16 and each screw hole 15 is located on the same plane as the thinnest part of each connecting portion 13. Each male splicing piece 20 has a screw part 21, and two screw parts 21 pass respectively through the two through holes 16 and are screwed in the two screw holes 15. As shown in FIG. 5, because the two connecting portions 13 are broken off at the thinnest part, the fracture surface of the two connecting portions 13 is exactly at the junction of the two through holes 16 and the two screw holes 15 and will not pass through the two screw holes 15, so as to ensure that the two screw parts 21 are completely screwed into the two screw holes 15. As such, the actual torque value of the body 11 and the two screw parts 21 is maintained at the predetermined torque value during locking, and the complete locking is achieved.

Preferably, as shown in FIG. 3, the cross-sectional shape of each groove 14 is V-shaped. Compared with other shapes, the V-shaped groove 14 has the advantage of being easy to process and manufacture. However, the user can modify the cross-sectional shape of the groove 14 according to the application.

As shown in FIG. 1 and FIG. 2, each through hole 16 is a round hole. Generally speaking, as shown in FIG. 3, one end of each male splicing piece 20 is a cylinder, and each steel rebar 100 is a cylinder with the surface having a thread-like protrusion structure. Therefore, the shape of each through hole 16 can correspond to the shape of one end of each male splicing piece 20 and each steel rebar 100. As shown in FIG. 4, one end of each male splicing piece 20 and each steel rebar 100 can enter each through hole 16 easily.

Generally speaking, the wrench usually engages a polygonal object. Therefore, as shown in FIG. 1 and FIG. 2, the shape of the two end portions 12 is polygonal, which helps the wrench to engage the two end portions 12 to drive the body 11 to rotate, wherein, the hexagonal shape is preferred.

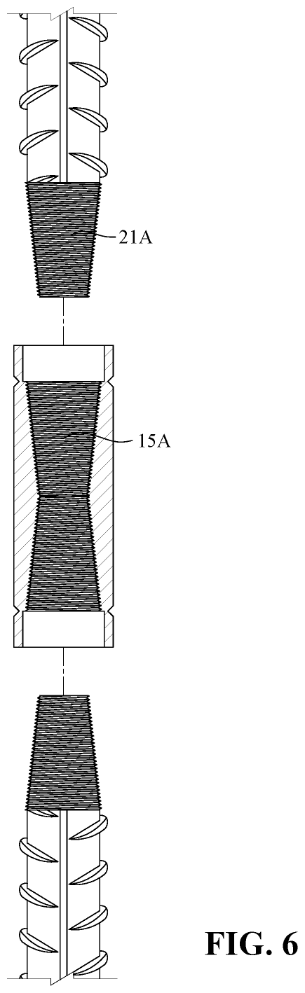

Referring to FIG. 6, FIG. 6 is an exploded view of the second embodiment of the present invention. The difference between the second embodiment and the first embodiment is that the cross-sectional shape of the screw hole 15A is tapered, and the cross-sectional shape of the screw part 21A is tapered. Otherwise, the remaining technical features of the second embodiment are the same as those of the first embodiment, and can achieve the same effects.

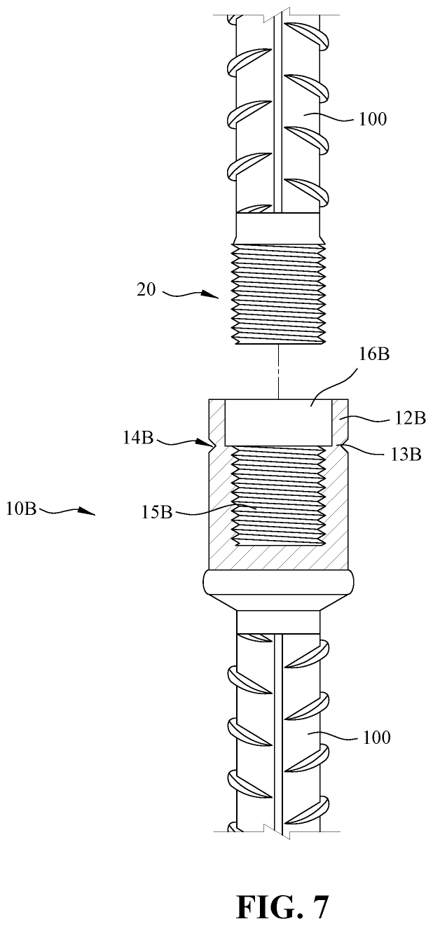

Referring to FIG. 7, FIG. 7 is an exploded view of the third embodiment of the present invention. The difference between the third embodiment and the first embodiment is that the female splicing piece 10B has only one end portion 12B, a connecting portion 13B, a groove 14B, a screw hole 15B and a through hole 16B. Also, the female splicing piece 10B is welded onto the steel rebar 100, and there is only one male splicing piece 20 in the present embodiment. The remaining technical features of the third embodiment are the same as those of the first embodiment, and can achieve the same effects.

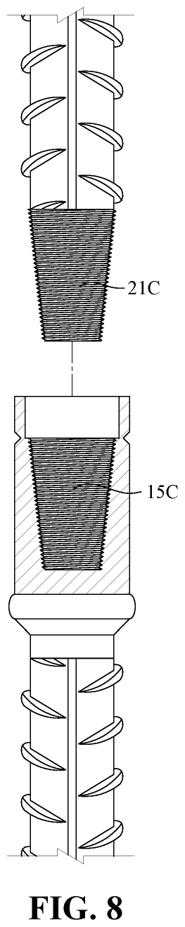

Referring to FIG. 8, FIG. 8 is an exploded view of the fourth embodiment of the present invention. The difference between the fourth embodiment and the third embodiment is that the cross-sectional shape of the screw hole 15C is tapered, and the cross-sectional shape of the screw part 21C is tapered. The remaining technical features of the fourth embodiment are the same as those of the third embodiment, and can achieve the same effects.

In summary, the rebar splicer of the present invention can enable inspectors to quickly visually check whether the rebar splicer has reached a predetermined torque value, thereby judging whether it is locked, eliminating complicated inspection procedures, shortening working hours, and achieving high efficiency.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A rebar splicer capable of enabling quick visual measuring of a predetermined torque value, comprising:
a female splicing piece, further comprising: a body, at least one end portion, and at least one connecting portion; the at least one connecting portion being disposed between at least one end of the body and the at least one end portion, and at least one groove being formed around outer side of the at least one connecting portion along a circumferential direction; the thickness of at least one connecting portion being smaller than the thickness of at least one end portion and the thickness of the body; and
at least one male splicing piece, passing through the at least one end portion and the at least one connecting portion of the female splicing piece and being fixed in the body of the female splicing piece.

2. The rebar splicer according to claim 1, wherein the at least one groove has a width in an axial direction, the width is tapered from the outside to the inside, and the deepest part of the at least one groove corresponds to the thinnest part of the at least one connecting portion.

3. The rebar splicer according to claim 2, wherein the female splicing piece is provided with at least one screw hole and at least one through hole, the at least one through hole communicates with the at least one screw hole, and a junction between the at least one through hole and the at least one screw hole is located on the same plane with the thinnest part of the at least one connecting portion; the at least one male splicing piece has a screw part, and the at least one screw part passes through the at least one through hole and is screwed and fixed in the at least one screw hole.

4. The rebar splicer according to claim 2, wherein the cross-sectional shape of the at least one groove is V-shaped.

5. The rebar splicer according to claim 3, wherein the at least one through hole is a round hole.

6. The rebar splicer according to claim 1, wherein the at least one end portion is polygonal.

7. The rebar splicer according to claim 1, wherein the female splicing piece comprises two end portions and two connecting portions, the two connecting portions are respectively disposed between the two ends of the body and the two end portions, and a groove is formed on outer side of each connecting part along a circumferential direction, so that the thickness of each connecting portion is less than the thickness of each end portion and the thickness of the body; and wherein, the rebar splicer comprises two male splicing pieces, the two male splicing pieces respectively pass through the two end portions and the two connecting portions and is fixed in the body.
